(19) United States
(12) Patent Application Publication
(10) Pub. No.: US 2007/0208567 A1
(43) Pub. Date: Sep. 6, 2007

(54) Error Correction In Automatic Speech Recognition Transcripts

(75) Inventors: Brian Amento, Morris Plains, NJ (US); Philip Locke Isenhour, Blacksburg, VA (US); Larry Stead, Montclair, NJ (US)

Correspondence Address: AT&T CORP., ROOM 2A207, ONE AT&T WAY, BEDMINSTER, NJ, 07921, US

(73) Assignee: AT&T Corp., New York, NY (US)

(21) Appl. No.: 11/276,476

(22) Filed: Mar. 1, 2006

(51) Int. Cl. G10L 21/00

(52) U.S. Cl. 704/270

(57) ABSTRACT

A method, a processing device, and a machine-readable medium are provided for improving speech processing. A transcript associated with the speech processing may be displayed to a user with a first visual indication of words having a confidence level within a first predetermined confidence range. An error correction facility may be provided for the user to correct errors in the displayed transcript. Error correction information, collected from use of the error correction facility, may be provided to a speech processing module to improve speech processing accuracy.

### BACKGROUND OF THE INVENTION

1. Field of the Invention

The present invention relates to error correction of a transcript generated by automatic speech recognition and more specifically to a system and method for visually indicating errors in a displayed automatic speech recognition transcript, correcting the errors in the transcript, and improving automatic speech recognition accuracy based on the corrected errors.

2. Introduction

Audio is a serial medium that does not naturally support searching or visual scanning. Typically, one must listen to a complete audio message in its entirety, thereby making it difficult for one to access relevant portions of the audio message. If the proper tools were available for easily retrieving and reviewing the audio messages, users may wish to archive important messages such as, for example, voice messages.

Automatic speech recognition may produce transcripts of audio messages that have a number of speech recognition errors. Such errors may make the transcripts difficult to understand and may limit usefulness of keyword searching. If users rely too heavily on having accurate transcripts, they may miss important details of the audio messages. Inaccuracy of transcripts produced by automatic speech recognition may discourage users from archiving important messages should an archiving capability become available.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

In a first aspect of the invention, a method is provided for improving speech processing. A transcript associated with the speech processing may be displayed to a user with a first visual indication of words having a confidence level within a first predetermined confidence range. An error correction facility may be provided for the user to correct errors in the displayed transcript. Error correction information, collected from use of the error correction facility, may be provided to a speech processing module to improve speech processing accuracy.

In a second aspect of the invention, a machine-readable medium having a group of instructions recorded thereon for at least one processor is provided. The machine-readable medium may include instructions for displaying a transcript associated with speech processing to a user with a first visual indication of words having a confidence level within a first predetermined confidence range, instructions for providing an error correction facility for the user to correct errors in the displayed transcript; and instructions for providing error correction information, collected from use of the error correction facility, to a speech processing module to improve speech processing accuracy.

In a third aspect of the invention, a device for displaying and correcting a transcript created by automatic speech recognition is provided. The device may include at least one processor, a memory operatively connected to the at least one processor, and a display device operatively connected to the at least one processor. The at least one processor may be arranged to display a transcript associated with speech processing to a user via the display device, where words having a confidence level within a first predetermined confidence range are to be displayed with a first visual indication, provide an error correction facility for the user to correct errors in the displayed transcript, and provide error correction information, collected from use of the error correction facility, to a speech processing module to improve speech recognition accuracy.

In a fourth aspect of the invention, a device for improving speech processing is provided. The device may include means for displaying a transcript associated with speech processing to a user with a first visual indication of words having a confidence level within a first predetermined confidence range, means for providing an error correction facility for the user to correct errors in the displayed transcript, and means for providing error correction information, collected from use of the error correction facility, to a speech processing module to improve speech processing accuracy.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary processing device in which implementations consistent with principles of the invention may execute;

FIG. 2 illustrates a functional block diagram of an implementation consistent with the principles of the invention;

FIG. 3 shows an exemplary display consistent with the principles of the invention;

FIG. 4 illustrates an exemplary lattice generated by an automatic speech recognizer;

FIG. 5 illustrates an exemplary Word Confusion Network (WCN) derived from the lattice of FIG. 4;

FIG. 6 shows an exemplary display and an exemplary word replacement menu consistent with the principles of the invention;

FIG. 7 shows an exemplary display and an exemplary phrase replacement dialog consistent with the principles of the invention;

FIG. 8 illustrates an exemplary display of a transcript with multiple types of visual indicators consistent with the principles of the invention; and

FIGS. 9A-9D are flowcharts that illustrate exemplary processing in implementations consistent with the principles of the invention.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

### Exemplary System

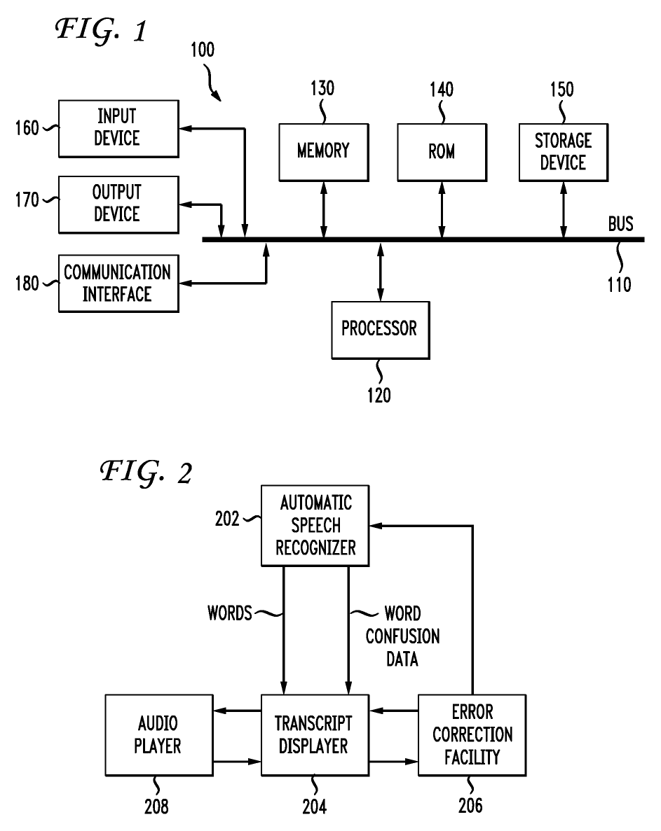

FIG. 1 illustrates a block diagram of an exemplary processing device 100 which may be used to implement systems and methods consistent with the principles of the invention. Processing device 100 may include a bus 110, a processor 120, a memory 130, a read only memory (ROM) 140, a storage device 150, an input device 160, an output device 170, and a communication interface 180. Bus 110 may permit communication among the components of processing device 100.

Processor 120 may include at least one conventional processor or microprocessor that interprets and executes instructions. Memory 130 may be a random access memory (RAM) or another type of dynamic storage device that stores information and instructions for execution by processor 120. Memory 130 may also store temporary variables or other intermediate information used during execution of instructions by processor 120. ROM 140 may include a conventional ROM device or another type of static storage device that stores static information and instructions for processor 120. Storage device 150 may include any type of media, such as, for example, magnetic or optical recording media and its corresponding drive.

Input device 160 may include one or more conventional mechanisms that permit a user to input information to system 200, such as a keyboard, a mouse, a pen, a voice recognition device, a microphone, a headset, etc. Output device 170 may include one or more conventional mechanisms that output information to the user, including a display, a printer, one or more speakers, a headset, or a medium, such as a memory, or a magnetic or optical disk and a corresponding disk drive. Communication interface 180 may include any transceiver-like mechanism that enables processing device 100 to communicate via a network. For example, communication interface 180 may include a modem, or an Ethernet interface for communicating via a local area network (LAN). Alternatively, communication interface 180 may include other mechanisms for communicating with other devices and/or systems via wired, wireless or optical connections. A stand-alone implementation of processing device 100 may not include communication interface 180.

Processing device 100 may perform such functions in response to processor 120 executing sequences of instructions contained in a computer-readable medium, such as, for example, memory 130, a magnetic disk, or an optical disk. Such instructions may be read into memory 130 from another computer-readable medium, such as storage device 150, or from a separate device via communication interface 180.

Processing device 100 may be, for example, a personal computer (PC), or any other type of processing device capable of processing textual data. In alternative implementations, such as, for example, a distributed processing implementation, a group of processing devices 100 may communicate with one another via a network such that various processors may perform operations pertaining to different aspects of the particular implementation.

FIG. 2 is a block diagram that illustrates functional aspects of exemplary processing device 100. Processing device 100 may include an automatic speech recognizer (ASR) 202, a transcript displayer 204, an error correction facility 206 and an audio player 208.

ASR 202 may be a conventional automatic speech recognizer that may include modifications to provide word confusion data from Word Confusion Networks (WCNs),which may include information with respect to hypothesized words and their respective confidence scores or estimated probabilities, to transcript displayer 204. In some implementations, ASR 202 may be included within a speech processing module, which may be configured to perform dialog management and speech generation, as well as speech recognition.

Transcript displayer 204 may receive best hypothesis words from ASR 202 to generate a display of a transcript of an audio message. ASR 202 may also provide transcript displayer 204 with the word confusion data. Transcript displayer 204 may use the word confusion data to provide a visual indication with respect to words having a confidence score or estimated probability less than a predetermined threshold. In one implementation consistent with the principles of the invention, a predetermined threshold of 0.93 may be used. However, other values may be used in other implementations. In some implementations consistent with the principles of the invention, the predetermined threshold may be configurable.

In implementations consistent with the principles of the invention, words having a confidence score greater than or equal to the predetermined threshold may be displayed, for example, in black letters, while words having a confidence score that is less than the predetermined threshold may be displayed in, for example, gray letters. Other visual indicators that may be used in other implementations to distinguish words having confidence scores below the predetermined threshold may include bolded letters, larger or smaller letters, italicized letters, underlined letters, colored letters, letters with a font different than a font of letters of words with confidence scores greater than or equal to the predetermined threshold, blinking letters, or highlighted letters, as well as other visual techniques.

In some implementations consistent with the principles of the invention, transcript displayer 204 may have multiple visual indicators. For example, a first visual indicator may be used with respect to words that have a confidence score that is less than a first predetermined threshold, but greater than or equal to a second predetermined threshold, a second visual indicator may be used with respect to words that have a confidence score that is less than a second predetermined threshold, but greater than or equal to a third predetermined threshold, and a third visual indicator may be used with respect to words that have a confidence score that is less than a third predetermined threshold.

Error correction facility 206 may include one or more tools for correcting errors in a transcript generated by ASR 202. In one implementation consistent with the principles of the invention, error correction facility 206 may include a menu-type error correction facility. With the menu-type error correction facility, a user may select a word that has a visual indicator. The selection may be made by placing a pointing device over the word for a period of time such as, for example, 4 seconds or some other time period. Other methods may be used to perform the selection as well, such as, for example, using a keyboard to move a cursor to the word and holding a key down, for example, a shift key, while using the keyboard to move the cursor across the letters of the word and then typing a particular key sequence such as, for example, ALT CTL E, or another key sequence. After selecting the word, error correction facility 206 may inform transcript displayer 204 to display a menu that includes a group of replacement words that the user may select to replace the selected word. The group of replacement words may be derived from the word confusion data of ASR 202. The displayed menu may include other options that may be selected by the user, such as, for example, an option to delete the word, type in another word, or have another group of replacement words displayed. The displayed menu may also display options for replacing a phrase of adjacent words, or for replacing a single word with multiple words.

Another tool that may be used in implementations of error correction facility 206 may be a select and replace tool. The select and replace tool may permit the user to select a phrase via a keyboard, a pointing device, a stylus or finger on a touchscreen, or other means and execute the select and replace tool by, for example, typing a key sequence on a keyboard, selecting an icon or button on a display or touchscreen, or by other means. The select and replace tool may cause a dialog box to appear on a display for the user to enter a replacement phrase.

After making transcript corrections with error correcting facility 206, error correcting facility 206 may provide correction information to ASR 202, such that ASR 202 may update its language and acoustical models to improve speech recognition accuracy.

Audio player 208 may permit the user to select a portion of the displayed transcript via a keyboard, a pointing device, a stylus or finger on a touchscreen, or other means, and to play audio corresponding to the selected portion of the transcript. In one implementation, the portion of the displayed transcript may be selected by placing a pointing device over a starting word of the portion, performing an action such as, for example, pressing a select button of the pointing device, dragging the pointing device to an ending word of the portion, and releasing the select button of the pointing device.

Each word of the transcript may have an associated timestamp indicating a time offset from a beginning of a corresponding audio file. when the user selects a portion of the transcript to play, audio player 208 may determine a time offset of a beginning of the selected portion and a time offset of an end of the selected portion and may then play a portion of the audio file corresponding to the selected portion of the displayed transcript. The audio file may be played through a speaker, an earphone, a headset, or other means.

### Exemplary Display

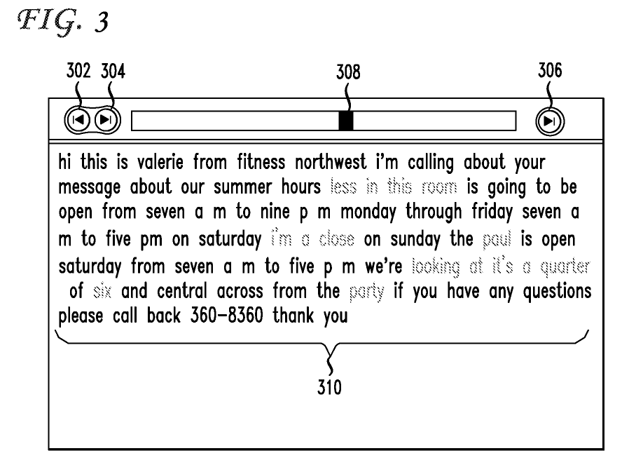

FIG. 3 shows an exemplary display that may be used in implementations consistent with the principles of the invention. The display may include audio controls 302, 304, 306, audio progress indicator 308 and displayed transcript 310.

The audio controls may include a fast reverse control 302, a fast forward control 304 and a play control 306. Selection of fast reverse control 302 may cause the audio to reverse to an earlier time. Selection of fast forward 304 may cause the audio to forward to a later time. Audio progress indicator 308 may move in accordance with fast forwarding, fast reversing, or playing to indicate a current point in the audio file. Play control 306 may be selected to cause the selected portion of the audio file to play. During playing, play control 306 may become a stop control to stop the playing of the audio file when selected. The above-mentioned controls may be selected by using a pointing device, a stylus, a keyboard, a finger on a touchscreen, or other means.

Displayed transcript 310 may indicate words that have a confidence score greater than or equal to a predetermined threshold, such as, for example, 0.93 or other suitable values, by displaying such words using, for example, black lettering. FIG. 3 shows words having a confidence score that is less than the predetermined threshold as being displayed using a visual indicator, such as, for example, words with gray letters. As mentioned previously, other visual indicators may be used in other implementations. In this particular implementation, ASR 202 may not perform capitalizations or insert punctuations, although, other implementations may include such features.

The error-free version of displayed transcript 310 is:
Hi, this is Valerie from Fitness Northeast. I'm calling about your message about our summer hours. Our fitness room is going to be open from 7:00am to 9:00pm, Monday through Friday, 7:00am to 5:00pm on Saturday, and we're closed on Sunday. The pool is open Saturday from 7:00am to 5:00pm. We're located at the corner of Sixth and Central across from the park. If you have any questions please call back, 360-8380. Thank you.

### Lattices and Word Confusion Networks

ASR 202, as well as conventional ASRs, may output a word lattice. The word lattice is a set of transition probabilities for a various hypothesized sequence of words. The transition probabilities include acoustic likelihoods (the probability that sounds present in a word are present in the input) and language model likelihoods, which may include, for example, the probability of a word following a previous word. Lattices include a complete picture of the ASR output, but may be unwieldy. A most probable path through the lattice is called the best hypothesis. The best hypothesis is typically the final output of an ASR.

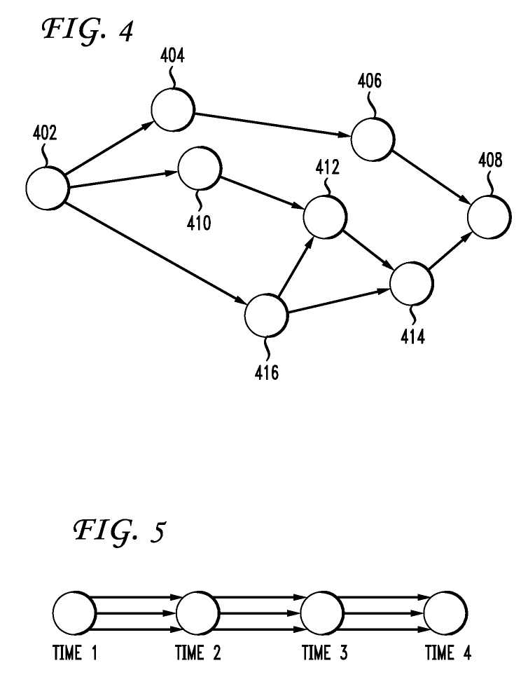

FIG. 4 illustrates a simple exemplary word lattice including words represented by nodes 402-416. For example, nodes 402, 404, 406 and 408 represent one possible sequence of words that may be generated by ASR from voice input. Nodes 402, 410, 412, 414 and 416 represent a second possible sequence of words that may be generated by ASR from the voice input. Nodes 402, 416, 414 and 408 represent a third possible sequence of words that may be generated by ASR from the voice input.

Word Confusion Networks (WCNs) attempt to compress lattices to a more basic structure that may still provide n-best hypotheses for an audio segment. FIG. 5 illustrates a structure of a WCN that corresponds to the lattice of FIG. 4. Competing words in the same possible time interval of the lattice maybe forced into a same group in a WCN, keeping an accurate time alignment. Thus, in the example of FIGS. 3 and 4, the word represented by node 402 may be grouped into a group corresponding to time 1, the words represented by nodes 404 and 410 may be grouped in a group corresponding to time 2, the words represented by nodes 406, 412 and 416 may be grouped into a group corresponding to time 3, and the words represented by nodes 414 and 408 may be grouped into a group corresponding to time 4. Each word in a WCN may have a posterior probability, which is the sum of the probabilities of all paths that contain the word at that approximate time frame. Implementations consistent with the principles of the invention may use the posterior probability as a word confidence score.

### Error Correction Facility

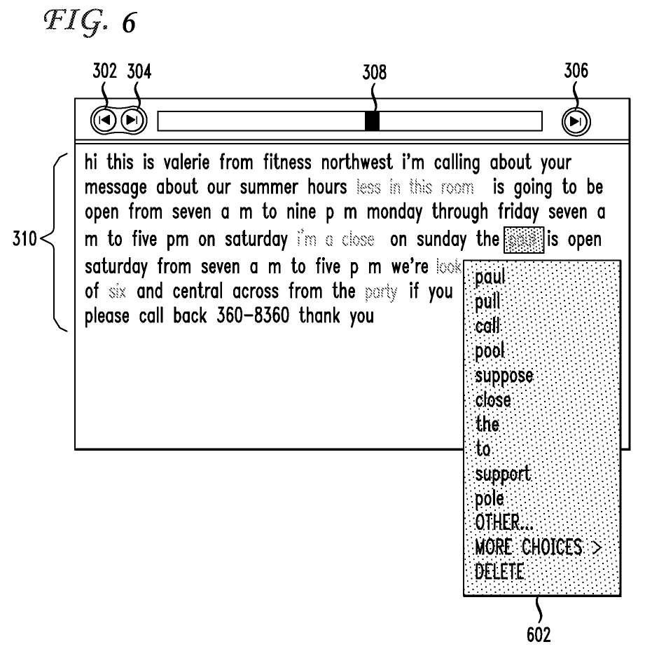

FIG. 6 illustrates use of a menu-type error correction tool that may be used to make corrections to displayed transcript 310 of FIG. 3. A user may select a word having a visual indicator indicating that the word has a confidence score that is less than a predetermined threshold. In this example, the user selects the word “paul”. The selection may be made using a pointing device, such as, for example, a computer mouse to place a cursor over “paul” for a specific amount of time, such as, for example, four seconds or some other time period. Alternatively, the user may right click the mouse after placing the cursor over the word to be changed. There are many other means by which the user may select a word in other implementations, as previously mentioned. After the word is selected, error correction facility 206 may cause a menu 602 to be displayed. Menu 602 may contain a number of possible replacement words, for example, 10 words, which may replace the selected word. Each of the possible replacement words may be derived from WCN data provided by ASR 202. The words may be listed in descending order based on confidence score. The user may select one of the possible replacement words using any number of possible selection means, such as the means previously mentioned, to cause error correction facility 206 to replace the selected word of the displayed transcript to be replaced with the selected word from menu 602.

Menu 602 may provide the user with additional choices. For example, if the user does not see the correct word among the menu choices, the user may select “other” which may cause a dialog box to appear to prompt the user to input a word that error correction facility 206 may use to replace the selected displayed transcript word. Further, the user may select “more choices” from menu 602, which may then cause a next group of possible replacement words to be displayed in menu 602. If the user finds an extra word in displayed transcript 310, the user may select the word and then select “delete” from menu 610 to cause deletion of the selected transcript word.

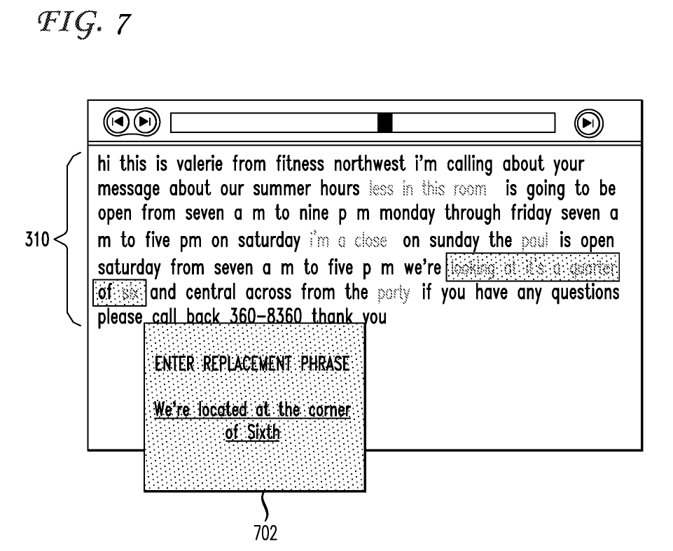

Another tool that may be implemented in error correction facility 206 is a select-and-replace tool. FIG. 7 illustrates displayed transcript 310 of FIG. 3. Using the select-and-replace tool, the user may select a phrase to be replaced in displayed transcript 310. The phrase may be selected in a number of different ways, as previously discussed. Once the phrase is selected, a dialog box 702 may appear on the display prompting the user to input a replacement phrase. Upon entering the replacement phrase, error correction facility 206 may replace the selected phrase in displayed transcript 310 with the newly input phrase.

When words and/or phrases are replaced, error correction facility 206 may provide information to ASR 202 indicating the word or phrase that is being replaced, along with the replacement word or phrase. ASR 202 may use this information to update its language and acoustical models such that ASR 202 may accurately transcribe the same phrases in the future.

### Multiple Visual Indicators

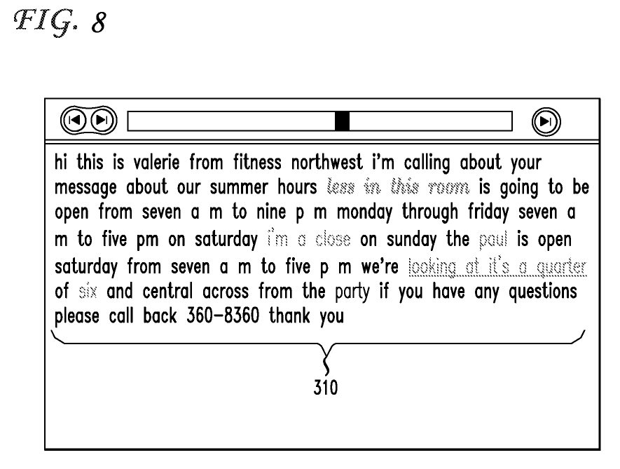

FIG. 8 shows an exemplary display of displayed transcript 310 having multiple types of visual indicators. The visual indicators may be used to indicate words that fall into one of several confidence score ranges. For example, referring to FIG. 8, “less in this room” is shown in gray italicized letters, “i'm a close”, “paul”, “six” and “party” are shown in gray letters, and “looking at it's a quarter” is shown in gray letters that are underlined. Each of the different types of indicators may indicate a different respective confidence score range, which in some implementations may be configurable.

### Exemplary Process

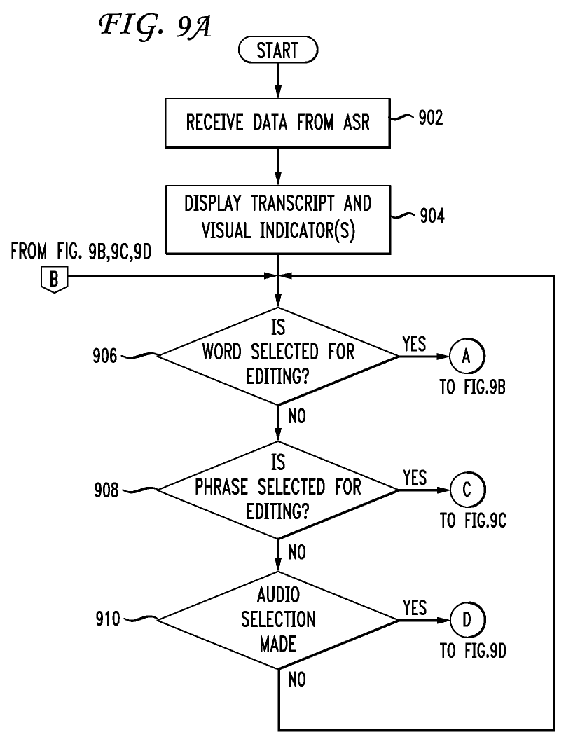

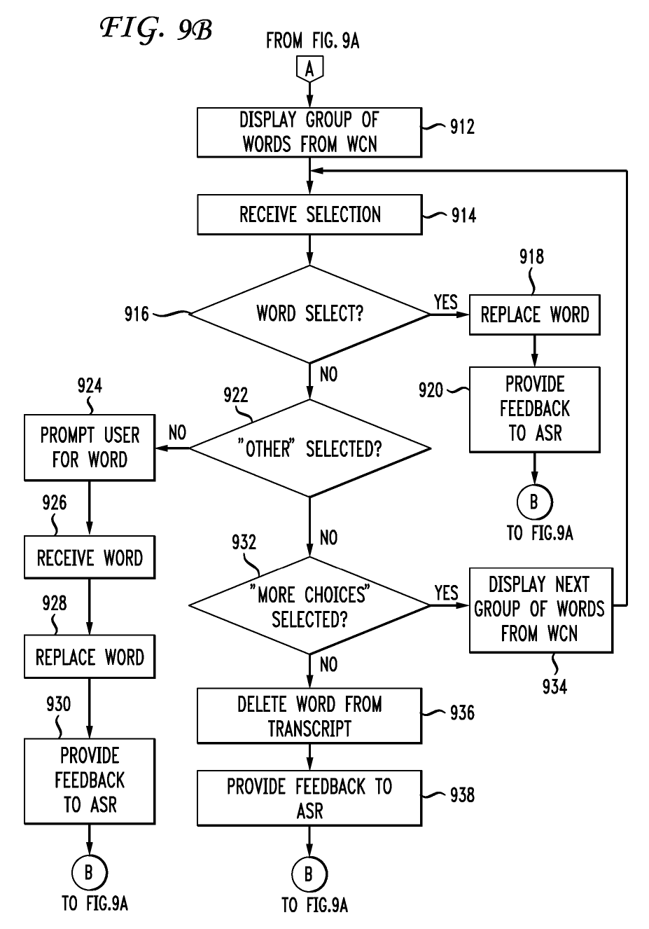

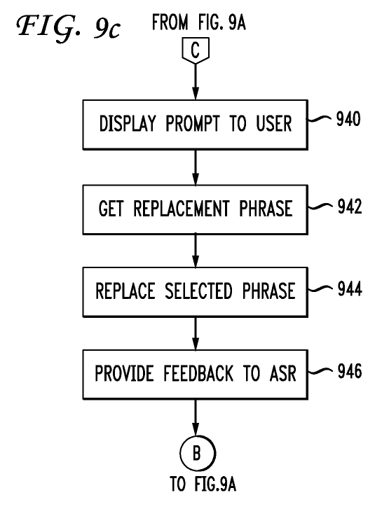

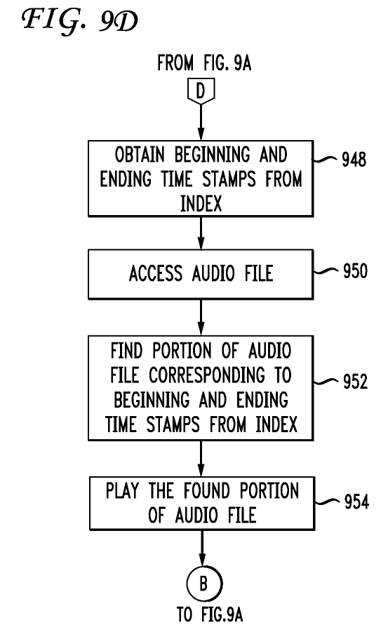

FIGS. 9A-9D are flowcharts that illustrate an exemplary process that may be performed in implementations consistent with the principles of the invention. The process assumes that audio input has already been received. The audio input may have been received in a form of voice signals or may have been received as an audio file. In either case, either the received audio file may be saved in memory 130 or storage device 150, or the received audio signals may be saved in an audio file in memory 130 or storage device 150.

The process may begin with ASR 202 processing the audio file and providing words for a transcript from a best hypothesis and word confusion data from WCNs (act 902). Transcript displayer 204 may receive the words and the word confusion data from ASR 202 and may display a transcript on a display device along with one or more types of visual indicators (act 904). Transport displayer 204 may determine word confidence scores from the provided word confusion data and may use one or more visual indicators to indicate a confidence score range of words having a confidence score less than a predetermined threshold. The visual indicators may include using different size fonts, different style fonts, different colored fonts, highlighted words, underlined words, blinking words, italicized words, bolded words, as well as other techniques.

Next, transcript displayer 204 may determine whether a word is selected for editing (act 906). If a word is selected for editing, then error correction facility 206 may display a menu, such as, for example, menu 602 (act 912; FIG. 9B). Menu 602 may list a group of possible replacement words derived from the word confusion data. The possible replacement words may be listed in descending order based on confidence scores determined by calculating a posterior probability of the possible replacement words. A user may then make a selection from menu 602, which may be received by error correction facility 206 (act 914). If a user selects one of the possible replacement words (act 916), error correction facility 206 may cause the selected word for editing to be replaced by the replacement word (act 918) and may send feedback data to ASR 202 such that ASR 202 may adjust language and acoustical models to make ASR 202 more accurate (act 920). Processing may then proceed to act 906 (FIG. 9A) to process the next selection.

If, at act 916 (FIG. 9B), error correction facility 206 determines that a word is not selected from menu 602, then error correction facility 206 may determine whether “other” was selected from menu 602 (act 922). If “other” was selected, then error correction facility 206 may cause a dialog box to be displayed prompting the user to enter a word (act 924). Error correction facility 206 may then receive the word entered by the user (act 926) and may replace the word selected for editing with the entered word (act 928). Error correction facility 206 may then send feedback data to ASR 202 such that ASR 202 may adjust language and acoustical models to make ASR 202 more accurate (act 930). Processing may then proceed to act 906 (FIG. 9A) to process the next selection.

If, at act 922 (FIG. 9B), error correction facility 206 determines that “other” was not selected, then error correction facility 206 may determine whether “more choices” was selected from menu 602 (act 932). If “more choices” was selected, then error correction facility 206 may obtain a next group of possible replacement words based on the word confusion data and posterior probabilities and may display the next group of possible replacement words in menu 602 (act 934). Error correction facility 206 may then proceed to act 914 to obtain the user's selection.

If, at act 932, error correction facility 206 determines that “more choices was not selected, then error correction facility 206 may assume that “delete” was selected. Error correction facility 206 may then delete the selected word from the displayed transcript (act 936) and may provide feedback to ASR 202 to improve speech recognition accuracy (act 938). Processing may then proceed to act 906 (FIG. 9A) to process the next selection.

If, at act 906, transcript displayer 204 determines that a word was not selected for editing, then transcript displayer 204 may determine whether a phrase was selected for editing (act 908). If transcript displayer 204 determines that a phrase was selected for editing, then error correction facility 206 may display a prompt, such as, for example, dialog box 702, requesting the user to enter a phrase to replace the selected phrase of the displayed transcript (act 940; FIG. 9C). Error correction facility 206 may receive the replacement phrase entered by the user (act 942). Error correction facility 206 may then replace the selected phrase of the displayed transcript with the replacement phrase (act 944) and may provide feedback to the ASR 202, such that ASR 202 may update its language and/or acoustical models to increase speech recognition accuracy (act 946). Processing may then proceed to act 906 (FIG. 9A) to process the next selection.

If at act 908 (FIG. 9A), transcript displayer 204 determines that a phrase for editing was not selected, then transcript displayer 204 may determine whether a portion of the displayed transcript was selected for audio player 208 to play (act 910). If so, then audio player 208 may refer to an index corresponding to a starting and ending word of the selected portion of the displayed transcript to obtain a starting and ending timestamp indicating a time offset from a beginning of the corresponding audio file for the selected portion and a duration of the selected portion (act 948; FIG. 9D). Audio player 208 may then access the audio file (act 950) and find a portion of the audio file that corresponds to the selected portion of the displayed transcript (act 952). Audio player 208 may then play the portion of the audio file (act 954). Processing may then proceed to act 906 (FIG. 9A) to process the next selection.

### Conclusion

The above-described embodiments are exemplary and are not limiting with respect to the scope of the invention. Embodiments within the scope of the present invention may include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in networked computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, hardwired logic may be used in implementations instead of processors, or one or more application specific integrated circuits (ASICs) may be used in implementations consistent with the principles of the invention. Further, implementations consistent with the principles of the invention may have more or fewer acts than as described, or may implement acts in a different order than as shown. Accordingly, the appended claims and their legal equivalents should only define the invention, rather than any specific examples given.

We claim as our invention:

1. A method for improving speech processing, the method comprising:
displaying a transcript associated with the speech processing to a user with a first visual indication of words having a confidence level within a first predetermined confidence range;
providing an error correction facility for the user to correct errors in the displayed transcript; and
providing error correction information, collected from use of the error correction facility, to a speech processing module to improve speech processing accuracy.

2. The method of claim 1, wherein the speech processing further comprises one of speech recognition, dialog management, or speech generation.

3. The method of claim 1, further comprising:
providing a selection mechanism for the user to select a portion of the displayed transcript including at least some of the words having a confidence level within the first predetermined confidence range; and
playing a portion of an audio file corresponding to the selected portion of the displayed transcript.

4. The method of claim 1, wherein displaying a transcript associated with the speech processing to a user further comprises:
providing a second visual indication with respect to words having a confidence level within a second predetermined confidence range.

5. The method of claim 4, wherein displaying a transcript associated with the speech processing to a user further comprises:
providing a third visual indication with respect to words having a confidence level within a third predetermined confidence range.

6. The method of claim 1, wherein providing an error correction facility for the user to correct errors in the displayed transcript further comprises:
providing a selection mechanism for the user to select a word from a plurality of displayed words;
displaying editing options including a list of replacement words; and
providing a selection mechanism for the user to select a word from the list of replacement words to replace the selected word from the plurality of displayed words.

7. The method of claim 6, wherein the list of replacement words is provided from a word confusion network of an automatic speech recognizer.

8. The method of claim 1, wherein providing an error correction facility for the user to correct errors in the displayed transcript further comprises:
providing a selection mechanism for the user to select a phrase included in the displayed transcript; and
providing a phrase replacement mechanism for a user to input a replacement phrase to replace the selected phrase.

9. A machine-readable medium having a plurality of instructions recorded thereon for at least one processor, the machine-readable medium comprising:
instructions for displaying a transcript associated with speech processing to a user with a first visual indication of words having a confidence level within a first predetermined confidence range;
instructions for providing an error correction facility for the user to correct errors in the displayed transcript; and
instructions for providing error correction information, collected from use of the error correction facility, to a speech processing module to improve speech processing accuracy.

10. The machine-readable medium of claim 9, wherein the speech processing comprises one of speech recognition, dialog management, or speech generation.

11. The machine-readable medium of claim 9, further comprising:
instructions for providing a selection mechanism for the user to select a portion of the displayed transcript including at least some of the words having a confidence level within the first predetermined confidence range; and
instructions for playing a portion of an audio file corresponding to the selected portion of the displayed transcript.

12. The machine-readable medium of claim 9, wherein the instructions for displaying a transcript associated with speech processing to a user further comprise:
instructions for providing a second visual indication with respect to words having a confidence level within a second predetermined confidence range.

13. The machine-readable medium of claim 9, wherein instructions for providing an error correction facility for the user to correct errors in the displayed transcript further comprise:
instructions for providing a selection mechanism for the user to select a word from a plurality of displayed words;
instructions for displaying editing options including a list of replacement words; and
instructions for providing a selection mechanism for the user to select a word from the list of replacement words to replace the selected word from the plurality of displayed words.

14. The machine-readable medium of claim 13, wherein the list of replacement words is provided from a word confusion network of an automatic speech recognizer.

15. The machine-readable medium of claim 9, wherein the instructions for providing an error correction facility for the user to correct errors in the displayed transcript further comprise:
instructions for providing a selection mechanism for the user to select a phrase included in the displayed transcript; and
instructions for providing a phrase replacement mechanism for a user to input a replacement phrase to replace the selected phrase

16. A device for improving speech processing, the device comprising:
at least one processor;
a memory operatively connected to the at least one processor, and
a display device operatively connected to the at least one processor, wherein the at least one processor is arranged to:
display a transcript associated with the speech processing to a user via the display device, words having a confidence level within a first predetermined range to be displayed with a first visual indication;
provide an error correction facility for the user to correct errors in the displayed transcript; and
provide error correction information, collected from use of the error correction facility, to a speech processing module to improve speech processing accuracy.

17. The device of claim 16, wherein the speech processing further comprises one of speech recognition, dialog management, or speech generation.

18. The device of claim 16, wherein the at least one processor is arranged to:
provide a selection mechanism for the user to select a portion of the displayed transcript including at least some of the words having a confidence level within the first predetermined confidence range; and
play a portion of an audio file corresponding to the selected portion of the displayed transcript.

19. The device of claim 16, wherein the at least one processor is further arranged to cause the words having a confidence level within a second predetermined confidence range to be displayed with a second visual indication via the display device.

20. The device of claim 16, wherein the at least one processor being arranged to provide an error correction facility for the user to correct errors in the displayed transcript, further comprises the at least one processor being arranged to:
provide a selection mechanism for the user to select a word from a plurality of displayed words;
display on the display device editing options including a list of replacement words; and
provide a selection mechanism for the user to select a word from the list of replacement words to replace the selected word of the plurality of displayed words.

21. The device of claim 20, wherein the list of replacement words is provided from a word confusion network of an automatic speech recognizer.

22. The device of claim 16, wherein the at least one processor being arranged to provide an error correction facility for the user to correct errors in the displayed transcript, further comprises the at least one processor being arranged to:
provide a selection mechanism for the user to select a phrase included in the displayed transcript; and
provide a phrase replacement mechanism for a user to input a replacement phrase to replace the selected phrase.

23. A device for improving speech processing, the device comprising:
means for displaying a transcript associated with the speech processing to a user with a first visual indication of words having a confidence level within a first predetermined confidence range;
means for providing an error correction facility for the user to correct errors in the displayed transcript; and
means for providing error correction information, collected from use of the error correction facility, to a speech processing module to improve speech processing accuracy.
